(19) United States
(12) Patent Application Publication
(10) Pub. No.: US 2009/0016537 A1
(43) Pub. Date: Jan. 15, 2009

(54) METHOD OF AUTHENTICATING AND REPRODUCING CONTENT USING PUBLIC BROADCAST ENCRYPTION AND APPARATUS THEREFOR

(75) Inventors: Hak-soo JU, Suwon-si (KR); Myung-sun KIM, Uiwang-si (KR); Ji-young MOON, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/048,656

(22) Filed: Mar. 14, 2008

(30) Foreign Application Priority Data
Jul. 9, 2007 (KR) 10-2007-0068805

(51) Int. Cl. H04L 9/08

(52) U.S. Cl. 380/278

(57) ABSTRACT

Provided are a method and apparatus for mutually authenticating devices in a group and reproducing content using public broadcast encryption. The method of authenticating a first device and a second device includes acquiring specific information of the second device from the second device, transmitting data, containing the acquired specific information of the second device and specific information of the first device, by encrypting the data using a broadcast public key of a group to which the second device belongs, and determining whether authentication of the first device succeeds by decrypting the encrypted data by using a private key of the second device. If authentication succeeds, receiving the specific information of the first device, which is encrypted by using a temporary common key by using the decrypted data, and authenticating the second device by decrypting the encrypted specific information of the first device by using the temporary common key.

### CROSS-REFERENCE TO RELATED PATENT APPLICATION

This application claims priority from of Korean Patent Application No. 10-2007-0068805, filed on Jul. 9, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to authenticating a first device and a second device and to reproducing content, and more particularly, to mutually authenticating devices in each device group and reproducing content using public broadcast encryption.

2. Description of the Related Art

FIG. 1 is a diagram illustrating a related system based on symmetric broadcast encryption.

Recently, transmission of digital content using various communication media, such as the Internet, terrestrial, cable, satellite, etc., has remarkably increased, and selling and lending of digital content using large-capacity recording media, such as compact disk (CD), digital versatile disk (DVD), blu-ray disk, etc., has also remarkably increased. Accordingly, digital rights management (DRM), which is a solution for protecting copyright of digital content, is becoming an important issue.

Among technologies related to DRM, broadcasting encryption for encrypting digital content, which is broadcasted using a recording medium, such as CD or DVD, or the Internet, is actively studied.

Referring to FIG. 1, the system includes a content provider (CP) 110 and groups 120, 130 and 140, which rightfully use content provided by the CP 110.

A related broadcast encryption method, such as content protection for recordable media (CPRM), an advanced access content system (AACS), or the like, is a symmetric method, and thus the CP 110 and a device of each of the groups 120, 103 and 140 include a common encryption key.

Accordingly, the common encryption key is a type of secret key. In other words, a broadcast key, which is used by the CP 110 to encrypt content, is the same as a key of the device of each of the groups 120, 130 and 140.

Such a symmetric broadcast encryption method has the following disadvantages.

First, when there is a plurality of CPs, the CPs share a broadcast key, corresponding to a secret key, in order to use the same system. Accordingly, when the broadcast key of one CP is exposed, the security of the other CPs is also compromised in a series.

Second, according to the symmetric broadcast encryption method, the CP has to maintain and manage key information about all devices in order to induce keys used to encrypt content. For example, when there are n groups and each group includes 10 devices, a device key of CPRM uses 16 keys of 56 bits. Accordingly, the CP has to maintain and manage 10×16×n=160n device keys.

### SUMMARY OF THE INVENTION

The present invention provides a method and apparatus for mutually authenticating devices in each device group and reproducing content using a broadcast public key of a group.

According to an aspect of the present invention, there is provided a method of authenticating a first device and a second device using public broadcast encryption, the method including: acquiring specific information of the second device from the second device; transmitting data, containing the acquired specific information of the second device and specific information of the first device, by encrypting the data using a broadcast public key of a group to which the second device belongs; receiving the specific information of the first device, which is encrypted by a temporary common key generated using the decrypted data, when authenticating the first device succeeds by decrypting the encrypted data using a private key of the second device; and authenticating the second device by decrypting the encrypted specific information of the first device using the temporary common key.

The second device may include content encrypted by a content encryption key and the content encryption key encrypted by a broadcast public key of a group, to which the first device belongs.

The temporary common key may be generated from a key derivation function (KDF), which has the specific information of the first and second devices as input values.

The specific information may be a serial number value of the first or second device, or a predetermined random number.

The authenticating of the first device may succeed when a serial number value or a random value acquired by decrypting the encrypted data using the private key of the second device matches the serial number value or the random value of the second device, and wherein the authenticating of the second device may succeed when a serial number value or a random value acquired by decrypting the encrypted specific information of the first device using the temporary common key matches the serial number value or the random value of the first device.

The broadcast public key may be acquired from a certificate which is acquired from a public directory server or acquired from the first or second device.

A structure of the certificate may follow an X.509 certificate format and subject public key information field included in the certificate comprises subject broadcast public key information.

According to another aspect of the present invention, there is provided a method of reproducing content using public broadcast encryption, wherein a first device receives the content from a second device, the method including: acquiring specific information of the second device from the second device, which comprises content, encrypted by a content encryption key, and the content encryption key, encrypted by a broadcast public key of a group to which the first device belongs; transmitting first data, which contains the acquired specific information of the second device and specific information of the first device, by encrypting the first data by a broadcast public key of a group to which the second device belongs; receiving second data, which contains the specific information of the first device, re-encrypted by a temporary common key generated using the decrypted first data, and the encrypted content encryption key and receiving the encrypted content, when authenticating of the first device succeeds by decrypting the first data by a private key of the second device; authenticating the second device by decrypting the second data by the temporary common key; re-decrypting the encrypted content encryption key included in the decrypted second data, by a private key of the first device, when authenticating of the second device succeeds; and decrypting the encrypted content using the decrypted content encryption key.

According to another aspect of the present invention, there is provided an apparatus for authenticating a first device and a second device using public broadcast encryption, the apparatus including: a receiver which acquires specific information of the second device from the second device; an encryption unit which encrypts data, containing the acquired specific information of the second device and specific information of the first device, by using a broadcast public key of a group to which the second device belongs; and a transmitter which transmits the encrypted data, wherein when authenticating of the first device succeeds by decrypting the encrypted data by a private key of the second device, the receiver receives the specific information of the first device encrypted by the temporary common key, and wherein the apparatus further includes: a decryption unit which decrypts the encrypted specific information of the first device by using a temporary common key generated using the data; and an authenticator which authenticates the second device based on the decrypted specific information of the first device.

According to another aspect of the present invention, there is provided an apparatus for reproducing content using public broadcast encryption, wherein a first device receives the content from a second device, the apparatus including: a receiver which acquires specific information of the second device from the second device, which comprises content, encrypted by a content encryption key, and the content encryption key, encrypted by a broadcast public key of a group to which the first device belongs; an encryption unit which encrypts first data, containing the acquired specific information of the second device and specific information of the first device, by using a broadcast public key of a group to which the second device belongs; and a transmitter which transmits the encrypted first data, wherein when the authenticating of the first device succeeds by decrypting the encrypted first data by a private key of the second device, the receiver receives second data, which contains the specific information of the first device, re-encrypted by a temporary common key generated using the decrypted first data, and the encrypted content encryption key, and the encrypted content, and wherein the apparatus further includes: a first decryption unit which decrypts the received second data by using the temporary common key; and an authenticator which authenticates the second device based on the decrypted specific information of the first device. The first decryption unit may include: a second decryption unit which re-decrypts the encrypted content encryption key included in the decrypted second data by using a private key of the first device when authenticating of the second device succeeds; and a third decryption unit which decrypts the encrypted content by using the decrypted content encryption key.

According to another aspect of the present invention, there is provided a computer readable recording medium having recorded thereon a program for executing the method of above.

### BRIEF DESCRIPTION OF THE DRAWINGS

The above and other features of the present invention will become more apparent by describing in detail exemplary embodiments thereof with reference to the attached drawings in which:

FIG. 1 is a diagram illustrating a related system based on symmetric broadcast encryption;

FIG. 2 is a diagram illustrating a system based on public broadcast encryption according to an exemplary embodiment of the present invention;

FIG. 3 is a flowchart illustrating a method of authenticating a first device and a second device using public broadcast encryption according to an exemplary embodiment of the present invention;

FIGS. 4A and 4B are diagrams illustrating certificate formats including a broadcast public key;

FIG. 5 is a flowchart illustrating in detail the method of FIG. 3;

FIG. 6 is a method of reproducing content using public broadcast encryption by a first device receiving the content from a second device according to an exemplary embodiment of the present invention;

FIG. 7 is a diagram describing operations of a method of reproducing content in a first device and a second device according to an exemplary embodiment of the present invention;

FIG. 8 is a flowchart illustrating in detail the method of FIG. 7;

FIG. 9 is a diagram describing operations of a method of reproducing content in a first device and a second device; and

FIG. 10 is a block diagram illustrating an apparatus for authenticating a first device and a second device according to an exemplary embodiment of the present invention.

In the drawings, like reference numerals denote like elements. Although the drawings illustrate exemplary embodiments of the present invention, they are not illustrated to scale, and some features may be exaggerated for clarity.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the exemplary embodiments of the present invention will be described in detail with reference to the attached drawings.

FIG. 2 is a diagram illustrating a system based on public broadcast encryption according to an embodiment of the present invention.

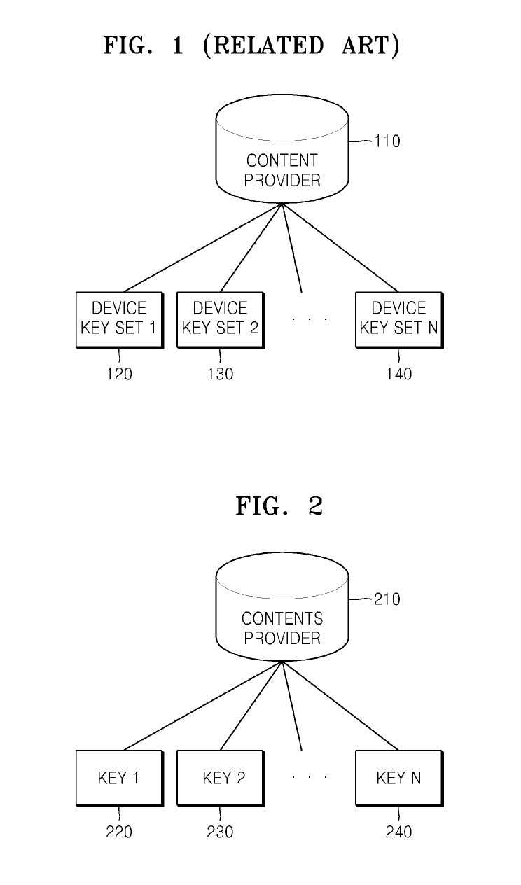

Referring to FIG. 2, unlike the system of FIG. 1, each of device groups 220, 230 and 240 includes a broadcast public key, which represents the groups 220, 230 and 240. Since a content provider (CP) 210 manages a public key of each of the groups 220, 230 and 240, the CP 210 possesses and manages n keys. Accordingly, the CP 220 is not affected by the number of device keys included in the groups 220, 230 and 240.

Moreover, the system according to the current embodiment of the present invention uses an asymmetric public key based encryption method, and thus a broadcast key is public information, not secret information. Accordingly, even when there is a plurality of CPs, each CP can use the same system by using the broadcast public key.

Methods of mutually authenticating devices in each group and reproducing content in the system of FIG. 2 will now be described.

In the present invention, n keys of a first device are formed of

(i) 1 broadcast public key: BPK1

(ii) n private keys: SK1_{—}i, (1≦i≦n).

Also, m keys of a second device are formed of

(iii) 1 broadcast public key: BPK2

(iv) m private keys: SK2_{—}j, (1≦j≦m).

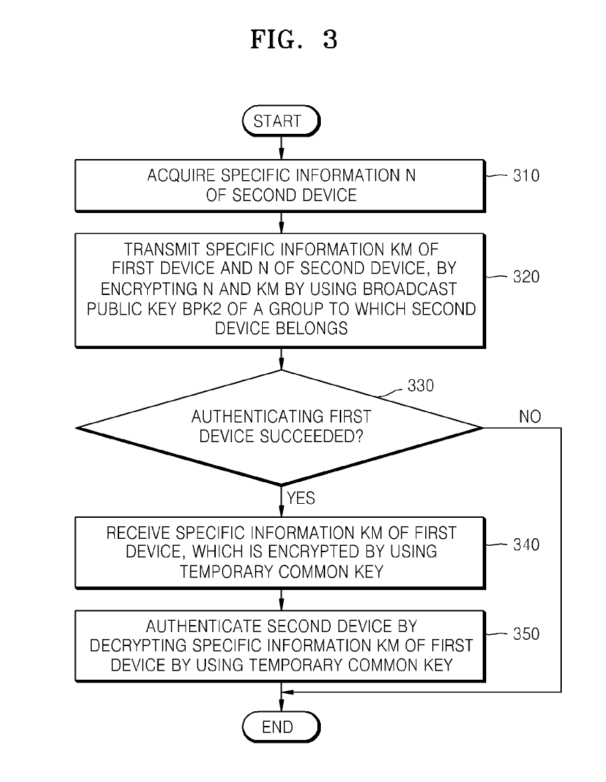

FIG. 3 is a flowchart illustrating a method of authenticating a first device and a second device using public broadcast encryption according to an exemplary embodiment of the present invention.

The method according to the current embodiment of the present invention includes acquiring specific information of the second device from the second device (operation 310), transmitting data, which contains the acquired specific information of the second device and specific information of the first device, by encrypting the data by using a broadcast public key of a group to which the second device belongs (operation 320), determining whether authentication of the first device succeeds by decrypting the data by using a private key of the second device (operation 330), receiving the specific information of the first device, which is encrypted by using a temporary common key generated using the decrypted data (operation 340), and authenticating the second device by decrypting the specific information of the first device by the temporary common key (operation 350).

That is, the first device is authenticated by the first device transmitting the specific information of the second device after public broadcast encryption of the specific information, and the second device is authenticated by receiving the specific information of the first device, which is encrypted by using the temporary common key derived from the specific information of the first and second devices.

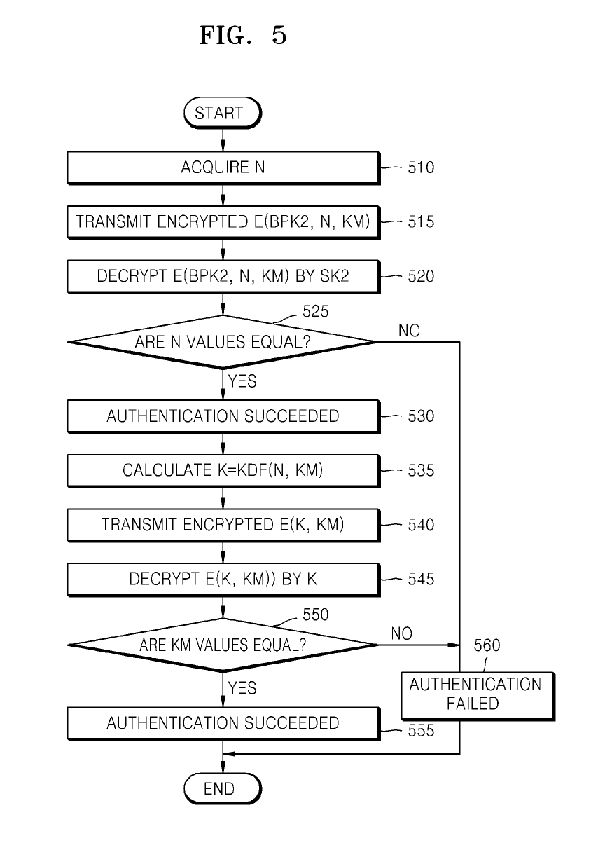

Detailed operations of the method and data transmitted/received between the first and second devices will be described in detail later with reference to FIG. 5.

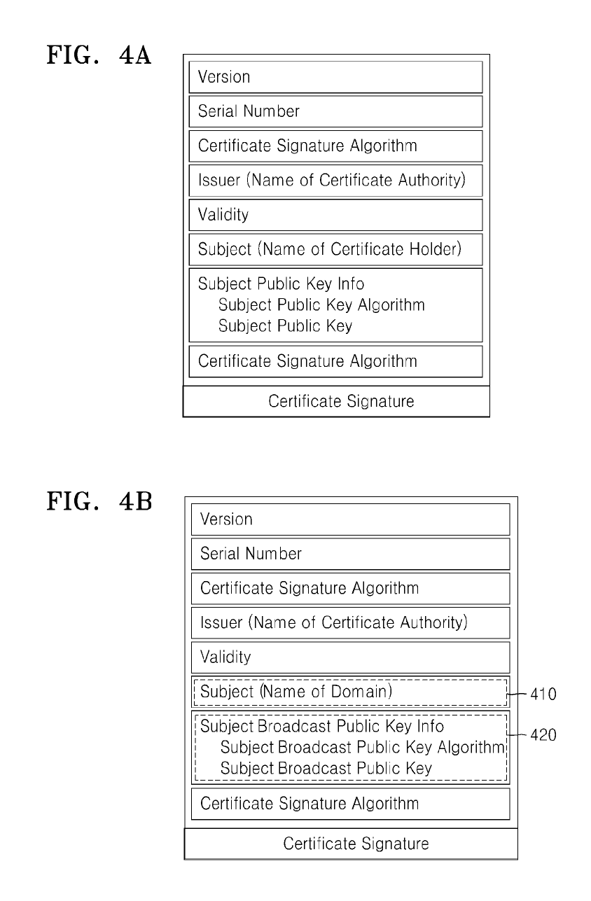

FIGS. 4A and 4B are diagrams illustrating certificate formats including a broadcast public key.

The broadcast public key used in the public broadcast encryption is included in a certificate issued by the Certificate Authority (CA).

Such a certificate can be acquired from a public directory server or from a first or second device. A structure of the certificate follows an X.509 certificate format.

X.509 is a public key based (PKI) ITU-T standard from among standards of a public key certificate and an authentication algorithm. An X.509 certificate denotes a client responsible individual (CRI) profile of the Internet Engineering Task Force (IETF) PKI certificate and X.509 v.3 certificate standards, and is defined in [RFC 3280].

Each field will now be described with reference to FIG. 4A.

(1) Version: A certificate format version of a certificate

(2) Serial Number: A serial number of each certificate, which is a specific number in an integer allocated by CA.

(3) Certificate Signature Algorithm: An identifier for identifying an algorithm, such as RSA or DSA, used by CA in order to sign a certificate

(4) Issuer (Name of Certificate Authority): The name of CA who issued and signed a certificate

(5) Validity: Validity of a certificate

(6) Subject (Name of Certificate Holder): A holder of a certificate. That is, a subject who possesses a public key shown on a public key item of a certificate. Here, each subject name confirmed by CA is a specific name.

(7) Subject Public Key Information: An identifier of an algorithm used by a key and a key value

(8) Certificate Signature Algorithm: An algorithm used by CA to sign a certificate

(9) Certificate Signature: An electronic signature. A message is generated in a value of predetermined length using a hash algorithm and then is encrypted by a private key of an issuer.

FIG. 4B illustrates an alternative example of the X.509 certificate format. Comparing the certificate formats of FIGS. 4A and 4B, a name of a domain 410 is illustrated in FIG. 4B instead of the name of a certificate holder in FIG. 4A, and subject broadcast public key information 420 is illustrated in FIG. 4B instead of the subject public key information in FIG. 4A.

FIG. 5 is a flowchart illustrating in detail the method of FIG. 3.

Operations of the method and data transmitted/received between the first and second devices will now be described with reference to FIG. 5. First, the first device acquires specific information N from the second device in operation 510. The specific information N is information that only the second device can generate and determine, such as a serial number value of the second device or a predetermined random value.

Also, the first device generates specific information KM (keying material), and similarly, the specific information KM may be a serial number value of the first device or a predetermined random value.

The first device transmits data E (BPK2, N, KM), in which N and KM are encrypted by a broadcast public key BPK2 of a group to which the second device belongs, in operation 515.

The second device decrypts the received data E (BPK2, N, KM) by a private key SK2_{—}j of the second device in operation 520. From among N and KM acquired by decrypting the data E (BPK2, N, KM), the second device checks whether the decrypted N is equal to the specific information N in operation 525.

When the decrypted N matches the specific information N, it is determined that authenticating the first device is succeeded in operation 530, and the second device calculates a temporary common key K in operation 535 by using N and KM as input values in a key derivation function (KDF). Here, the KDF is a function for generating a key which has the same output value as the input value.

Data E (K, KM), in which the specific information KM of the first device is encrypted using the calculated temporary common key K, is transmitted in operation 540. Upon receiving the data E (K, KM), the first device derives the temporary common key K in the same manner as the second device using the N and KM in itself, and then decrypts the data E (K, KM) by the temporary common key K, that is D (K, E (K, KM)) in operation 545.

When KM obtained by decrypting the data E (K, KM) matches the specific information KM of the first device in operation 550, it is determined that authentication of the second device has succeeded in operation 555.

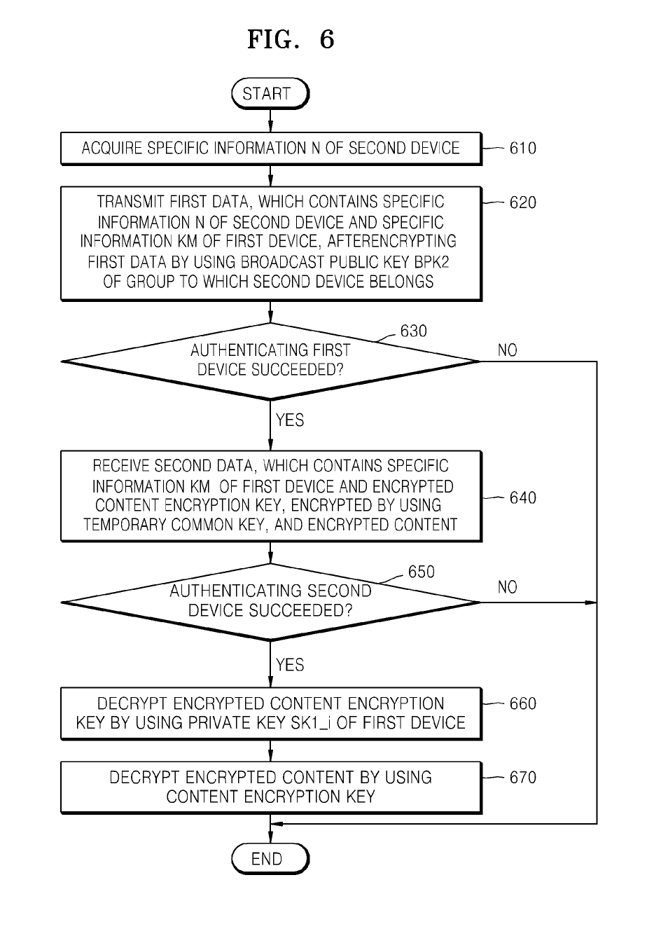

FIG. 6 is a method of reproducing content using public broadcast encryption by a first device receiving the content from a second device according to an exemplary embodiment of the present invention.

Referring to FIG. 6, the method according to the current embodiment of the present invention includes acquiring specific information of the second device from the second device, which includes content, encrypted by a content encryption key (CEK), and the content encryption key, encrypted by a broadcast public key of a group to which the first device belongs (operation 610), transmitting first data, which contains the acquired specific information of the second device and specific information of the first device, after encrypting the first data by a broadcast public key of a group to which the second device belongs (operation 620), determining whether authentication of the first device succeeds by decrypting the encrypted first data by a private key of the second device (operation 630), receiving second data, which contains the specific information of the first device, re-encrypted by a temporary common key generated using the decrypted first data, and the encrypted content encryption key, and receiving the encrypted content (operation 640), determining whether authentication of the second device succeeds by decrypting the received second data by the temporary common key (operation 650), re-decrypting the encrypted content key included in the decrypted second data by a private key of the first device (operation 660), and decrypting the encrypted content by using the content encryption key (operation 670).

Comparing the method of FIG. 6 and the method of FIG. 3, the method of FIG. 6 further includes the first device decrypting the content encryption key by the private key SK1_{—}i of the first device after authenticating the first and second devices, and decrypting the encrypted content E (CEK, Content) by the content encryption key.

For the above operations, the second device encrypts data, which contains not only the specific information KM of the first device but also the encrypted content encryption key E (BPK1, CEK), using the temporary common key K, and transmits the encrypted data to the first device. Moreover, the encrypted content E (CEK, Content) is also transmitted.

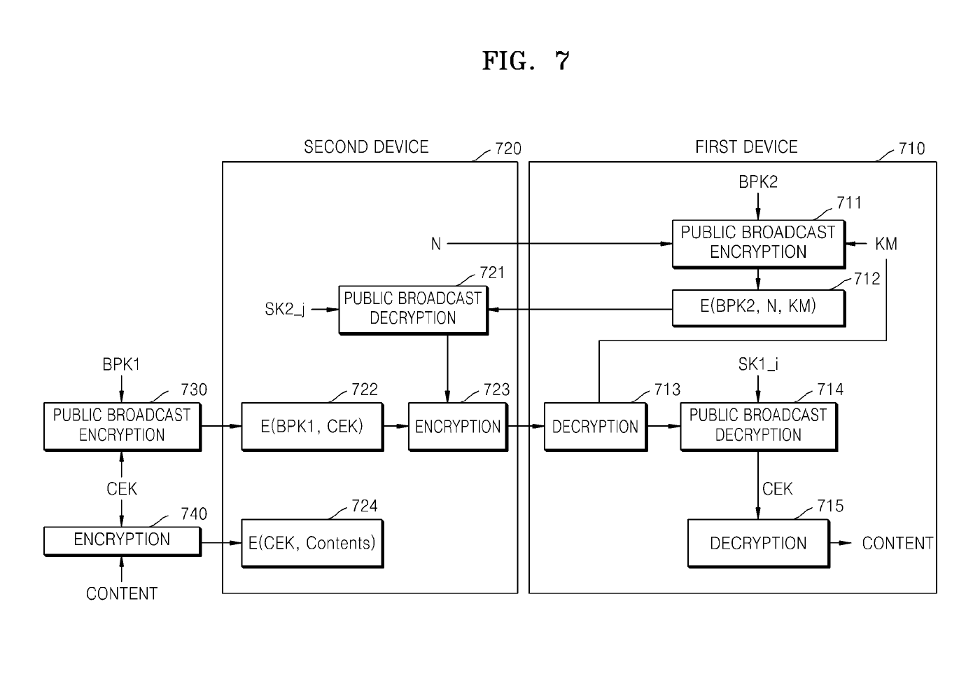

Detailed operations and data transmitted/received between the first and second devices will now be described in detail with reference to FIG. 7, while describing operations of encryption and decryption in each of the first and second devices.

FIG. 7 is a diagram for describing operations of a method of reproducing content in a first device 710 and a second device 720 according to an exemplary embodiment of the present invention.

Referring to FIG. 7, processes of a CP, which comprise encrypting content and storing the encrypted content in the second device 720, will now be described.

(i) The CP generates a content encryption key (CEK).

(ii) Using the CEK, the CP encrypts the content in a symmetric key encryption method (operation 740).

(iii) The CP acquires a certificate of the first device 710 (for example, a reproducing apparatus) from a public directory server.

(iv) The CP acquires a broadcast public key BPK1 of the first device 710 from the certificate of the first device 710.

(v) The CP encrypts the CEK by the broadcast public key BPK1 of the first device 710 using a public broadcast encryption method (operation 730).

(vi) The CP stores the encrypted content and CEK in the second device 720 (for example, a mobile storage medium).

Accordingly, the encrypted CEK E (BPK1, CEK) 722 and the encrypted content E (CEK, Content) 724 are stored in the second device 720, and after the first and second devices 710 and 720 mutually authenticate each other, the first device 710 decrypts and reproduces the encrypted content E (CEK, Content) 724.

Looking at the first device 710, the first device 710 acquires specific information N from the second device, and public broadcast encrypts the specific information N of the second device and specific information KM of the first device using a previously acquired broadcast public key BPK2 (operation 711).

When data E (BPK2, N, KM) encrypted accordingly is transmitted to the second device 720, the second device 720 decrypts the data E (BPK2, N, KM) by a private key SK2_{—}j of the second device 720 (operation 721). From among N and KM acquired by decrypting the data E (BPK2, N, KM), the second device 720 checks whether the decrypted N matches the specific information N, and calculates a temporary common key K by using N and KM as input values in the KDF.

Using the calculated temporary common key K, the second device 720 encrypts data, which contains not only the specific information KM of the first device 710 but also the encrypted content encryption key E (BPK1, CEK), and transmits the encrypted data to the first device 710 (operation 723).

Upon receiving the encrypted data, the first device 710 derives the temporary common key K in the same manner as the second device 720 using N and KM stored in the first device 710, and then decrypts the data by the temporary common key K (D (K, E (K, KM∥E (BPK1, CEK))), operation 713). Here, ‘∥’ denotes a concatenation.

When KM acquired by decrypting the data is equal to the specific information KM of the first device 710, the first device 710 decrypts the encrypted content encryption key E (BPK1, CEK) by a private key SK1_{—}i of the first device 710 (operation 714), and decrypts the encrypted content E (CEK, Contents) by the content key CEK (operation 715).

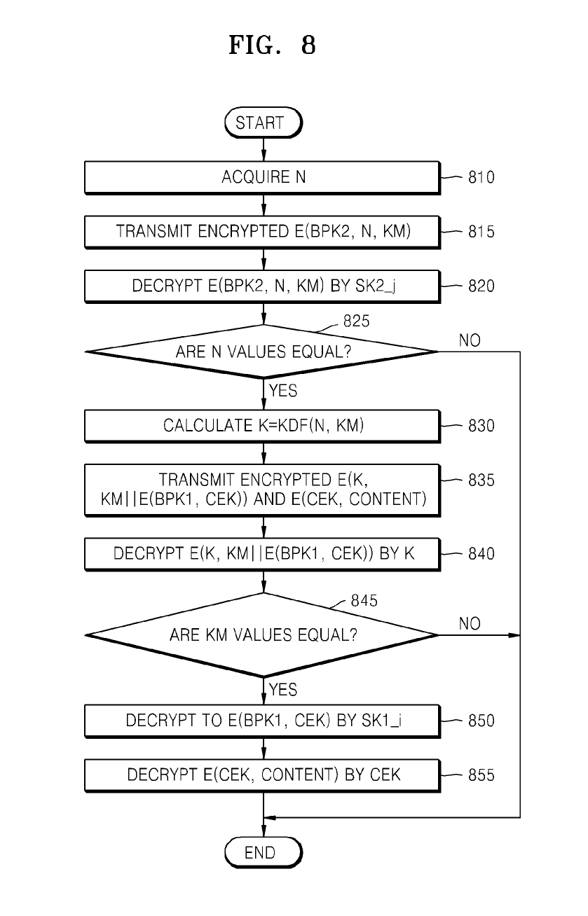

FIG. 8 is a flowchart illustrating in detail the method of FIG. 7.

Referring to FIG. 8, the method performs authenticating a first device and a second device using public broadcast encryption of FIG. 5 and further includes the first device decrypting the encrypted content key E (BPK1, CEK) by the private key SK1_{—}i of the first device ((D (SK1_{—}i, E (BPK1, CEK)), operation 850), and decrypting the encrypted content E (CEK, Content) by the content encryption key CEK (D (CEK, E (CEK, Contents)), operation 855).

Accordingly, in operation 835, the second device encrypts data, which contains not only the specific information KM of the first device but also the encrypted content key E (BPK1, CEK), by the temporary common key K, and transmits the encrypted data to the first device. Also in operation 835, the second device transmits the encrypted content E (CEK, Content).

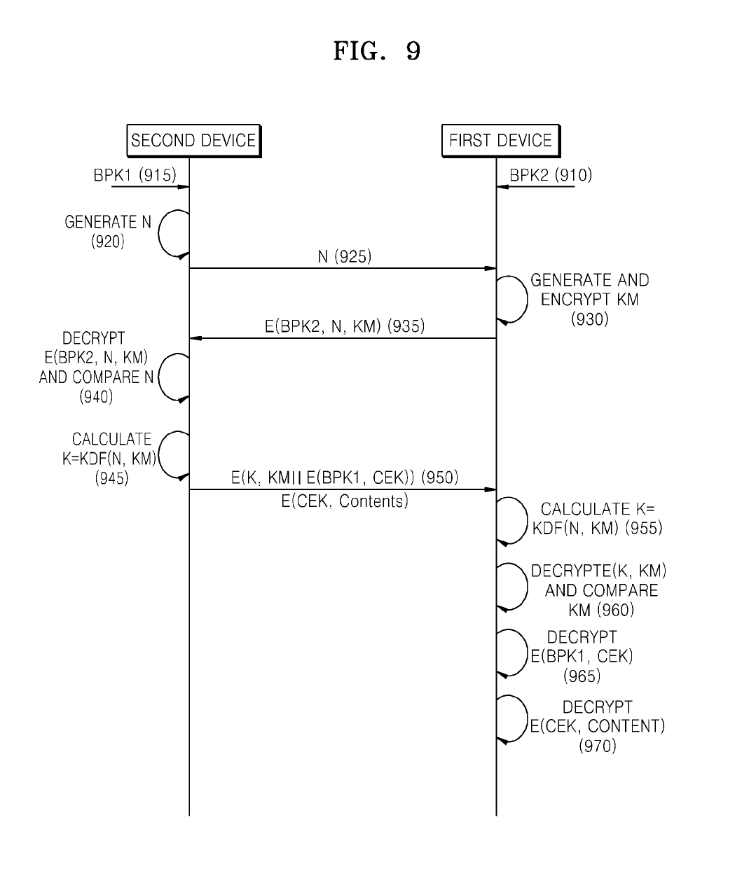

FIG. 9 is a diagram for describing operations of a method of reproducing content in a first device and a second device.

Operations in the first and second devices will now be described with reference to FIG. 9. First, the first and second devices respectively possess broadcast public keys BPK1 and BPK2 by acquiring certificates of each other in operations 910 and 915.

In operation 920, the second device generates N, which is specific information of the second device, such as a serial number value of the second device or a predetermined random value.

In operation 925, the first device acquires N from the second device.

In operation 930, the first device generates KM, which is specific information of the first device, and as described above in relation to N, KM may be a serial number value of the first device or a predetermined random value.

In operation 935, the first device transmits data E (BPK2, N, KM), which contains N and KM, after encrypting the data E (BPK2, N, KM) by a broadcast public key BPK2 of a group to which the second device belongs.

In operation 940, the second device decrypts the data E (BPK2, N, KM) by a private key SK2_{—}j of the second device. From among N and KM acquired by decrypting the data E (BPK2, N, KM), the second device compares and checks whether N matches the specific information of the second device.

When N and the specific information of the second device match, it is determined that authentication of the first device has succeeded, and the second device calculates a temporary common key K by using N and KM as input values in the KDF in operation 945.

In operation 950, the second device encrypts data, which contains not only the specific information KM of the first device but also the encrypted content encryption key E (BPK1, CEK), using the temporary common key K, and transmits the encrypted data to the first device. Also, the second device transmits the encrypted content E (CEK, Content) to the first device.

Upon receiving the encrypted data, the first device derives the temporary common key K in the same manner as the second device using N and KM in itself in operation 955.

In operation 960, the first device decrypts (D (K, E (K, KM))) the data by the derived temporary common key K, and checks whether KM, acquired by decrypting the data, matches the specific information KM of the first device.

When KM and the specific information KM match, it is determined that authentication of the second device has succeeded, and the first device decrypts the encrypted content encryption key E (BPK1, CEK) by a private key SK1_{—}i of the first device in operation 965.

In operation 970, the first device decrypts the encrypted content E (CEK, Content) using the decrypted content encryption key CEK.

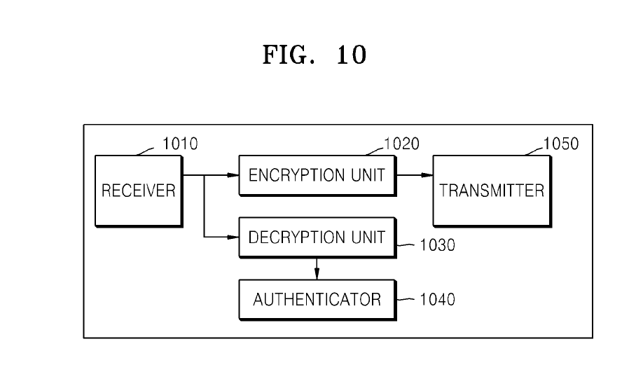

FIG. 10 is a block diagram illustrating an apparatus for authenticating a first device and a second device according to an exemplary embodiment of the present invention.

Referring to FIG. 10, the apparatus includes a receiver 1010, which acquires specific information of the second device from the second device or receives specific information of the first device encrypted by a temporary common key, an encryption unit 1020, which encrypts data, containing the specific information of the first and second devices, by a broadcast public key of a group to which the second device belongs, and a transmitter 1050, which transmits the encrypted data. The apparatus further includes a decryption unit 1030, which decrypts the encrypted specific information of the first device by a temporary common key, and an authenticator 1040, which authenticates the second device based on the decrypted specific information of the first device.

An apparatus for reproducing content includes the elements of the apparatus of FIG. 10, and the decryption unit 1030 may further include a first decryption unit, which decrypts the received data by the temporary common key, a second decryption unit, which re-decrypts the encrypted content encryption key included in the decrypted data by a private key of the first device, and a third decryption unit, which decrypts the encrypted content using the decrypted content encryption key.

The exemplary embodiments of the present invention can be written on a computer readable recording medium as computer programs and can be implemented in general-use digital computers that execute the programs using a computer readable recording medium.

Also as described above, the data structure used in the present invention can be recorded on the computer readable recording medium by various means.

Examples of the computer readable recording medium include magnetic storage media (e.g., ROM, floppy disks, hard disks, etc.) and optical recording media (e.g., CD-ROMs, or DVDs). Other storage media may include carrier waves (e.g., transmission through the Internet).

As described above, according to the method and apparatus for authenticating and reproducing content using public broadcast encryption, a CP only possesses and manages a public key of each group, and is not affected by the number of device keys. Also, even when there is a plurality of CPs, each CP can use the same system using a public broadcast key, and thus scalability of the CPs can be guaranteed.

Moreover, while mutually authenticating devices in a group, a mutual common key can be efficiently acquired using broadcast encryption, and a bidirectional revocation function can be supported.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of authenticating a first device and a second device using public broadcast encryption, the method comprising:
acquiring specific information of the second device from the second device;
transmitting data, containing the acquired specific information of the second device and specific information of the first device, by encrypting the data using a broadcast public key of a group to which the second device belongs; and
determining whether authenticating the first device succeeds by decrypting the encrypted data using a private key of the second device;
wherein, if the authenticating of the first device succeeds:
receiving the specific information of the first device, which is encrypted by a temporary common key generated using the decrypted data; and
authenticating the second device by decrypting the encrypted specific information of the first device using the temporary common key.

2. The method of claim 1, wherein the second device comprises content encrypted by a content encryption key and the content encryption key encrypted by a broadcast public key of a group, to which the first device belongs.

3. The method of claim 2, wherein the temporary common key is generated from a key derivation function (KDF), which has the specific information of the first and second devices as input values.

4. The method of claim 3, wherein the specific information of the first device is a serial number value of the first device or a first random number, and the specific information of the second device is a serial number value of the second device or a second random number.

5. The method of claim 4, wherein the authenticating of the first device succeeds if a serial number value or a random value acquired by decrypting the encrypted data using the private key of the second device matches the serial number value of the second device or the second random value, and wherein the authenticating of the second device succeeds if a serial number value or a random value acquired by decrypting the encrypted specific information of the first device using the temporary common key matches the serial number value of the first device or the first random value.

6. The method of claim 5, wherein the broadcast public key is acquired from a certificate which is acquired from a public directory server or acquired from the first or second device.

7. The method of claim 6, wherein a structure of the certificate follows an X.509 certificate format and subject public key information field included in the certificate comprises subject broadcast public key information.

8. A method of reproducing content using public broadcast encryption, wherein a first device receives the content from a second device, the method comprising:
acquiring specific information of the second device from the second device, which comprises content, encrypted by a content encryption key, and the content encryption key, encrypted by a broadcast public key of a group to which the first device belongs;
transmitting first data, which contains the acquired specific information of the second device and specific information of the first device, by encrypting the first data by a broadcast public key of a group to which the second device belongs; and
determining whether authenticating the first device succeeds by decrypting the first data by a private key of the second device;wherein, if the authenticating of the first device succeeds:
receiving second data, which contains the specific information of the first device, re-encrypted by a temporary common key generated using the decrypted first data, and the encrypted content encryption key, and receiving the encrypted content;
authenticating the second device by decrypting the second data by the temporary common key; and
determining whether authenticating of the second device succeeds; and
wherein, if the authenticating of the second device succeeds:
re-decrypting the encrypted content encryption key included in the decrypted second data, by a private key of the first device; and
decrypting the encrypted content using the decrypted content encryption key.

9. The method of claim 8, wherein the temporary common key is generated from a key derivation function (KDF), which has the specific information of the first and second devices as input values.

10. The method of claim 9, wherein the specific information of the first device is a serial number value of the first device, or a first random number, and the specific information of the second device is a serial number value of the second device or a second random number.

11. The method of claim 10, wherein the authenticating of the first device succeeds if a serial number value or a random value acquired by decrypting the encrypted first data using the private key of the second device matches the serial number value of the second device or the second random value and wherein the authenticating of the second device succeeds if a serial number value or a random value acquired by decrypting the second data using the temporary common key matches the serial number value of the first device or the first random value.

12. The method of claim 11, wherein the broadcast public key is acquired from a certificate which is acquired from a public directory server or acquired from the first or second device.

13. The method of claim 12, wherein a structure of the certificate follows an X.509 certificate format and subject public key information field included in the certificate comprises subject broadcast public key information.

14. An apparatus for authenticating a first device and a second device using public broadcast encryption, the apparatus comprising:
a receiver which acquires specific information of the second device from the second device;
an encryption unit which encrypts data, containing the acquired specific information of the second device and specific information of the first device, by using a broadcast public key of a group to which the second device belongs; and
a transmitter which transmits the encrypted data,
wherein if authenticating of the first device succeeds by decrypting the encrypted data by a private key of the second device, the receiver receives the specific information of the first device encrypted by a temporary common key,
wherein the apparatus further comprises:
a decryption unit which decrypts the encrypted specific information of the first device by using the temporary common key generated using the data; and
an authenticator which authenticates the second device based on the decrypted specific information of the first device.

15. The apparatus of claim 14, wherein the second device comprises content, encrypted by a content encryption key, and the content encryption key, encrypted by a broadcast public key of a group to which the first device belongs.

16. The apparatus of claim 15, wherein the temporary common key is generated from a key derivation function (KDF), which has the specific information of the first and second devices as input values.

17. The apparatus of claim 16, wherein the specific information of the first device is a serial number value of the first device or a first random number, and the specific information of the second device is a serial number value of the second device or a second random number.

18. The apparatus of claim 17, wherein the authenticator succeeds in authenticating the second device if a serial number value or a random value acquired by decrypting the encrypted specific information of the first device using the temporary common key matches the serial number value of the first device or the first random value.

19. The apparatus of claim 18, wherein the broadcast public key is acquired from a public directory server or extracted from a certificate, which is acquired from the first or second device, wherein a structure of the certificate follows an X.509 certificate format.

20. An apparatus for reproducing content using public broadcast encryption, wherein a first device receives the content from a second device, the apparatus comprising:
a receiver which acquires specific information of the second device from the second device, which comprises content, encrypted by a content encryption key, and the content encryption key, encrypted by a broadcast public key of a group to which the first device belongs;
an encryption unit which encrypts first data, containing the acquired specific information of the second device and specific information of the first device, by using a broadcast public key of a group to which the second device belongs; and
a transmitter which transmits the encrypted first data;
wherein if the authenticating of the first device succeeds by decrypting the encrypted first data by a private key of the second device, the receiver receives second data, which contains the specific information of the first device, re-encrypted by a temporary common key generated using the decrypted first data, and the encrypted content encryption key, and the encrypted content,
wherein the apparatus further comprises:
a first decryption unit which decrypts the received second data by using the temporary common key; and
an authenticator which authenticates the second device based on the decrypted specific information of the first device.
wherein the first decryption unit comprises:
a second decryption unit which re-decrypts the encrypted content encryption key included in the decrypted second data by using a private key of the first device, if authenticating of the second device succeeds; and
a third decryption unit which decrypts the encrypted content by using the decrypted content encryption key.

21. The apparatus of claim 20, wherein the temporary common key is generated from a key derivation function (KDF), which has the specific information of the first and second devices as input values.

22. The apparatus of claim 21, wherein the specific information of the first device is a serial number value of the first device, or a first random number, and the specific information of the second device is a serial number value of the second device or a second random number.

23. The apparatus of claim 22, wherein the authenticator succeeds in authenticating the second device if a serial number value or a random value acquired by decrypting the second data using the temporary common key matches the serial number value of the first device or the first random value of the first device.

24. The apparatus of claim 23, wherein the broadcast public key is acquired from a public directory server or extracted from a certificate, which is acquired from the first or second device, wherein a structure of the certificate follows an X.509 certificate format.

25. A computer readable recording medium having recorded thereon a program for executing by a computer the method of claim 8.
